(19) United States
(12) Patent Application Publication
(10) Pub. No.: US 2007/0055701 A1
(43) Pub. Date: Mar. 8, 2007

(54) Method and telecommunications node for information synchronization

(76) Inventors: Edwin Tse, Montreal (CA); Nicolas Gosselin, Blainville (CA); Andre Godin, Laval (CA)

Correspondence Address: Alex Nicolaescu;Ericsson Canada Inc., Patent Department, 8400 Decarie Blvd., Town Mount Royal, QC, H4P 2N2, CA

(21) Appl. No.: 11/220,558

(22) Filed: Sep. 8, 2005

(51) Int. Cl. G06F 17/30

(52) U.S. Cl. 707/200

(57) ABSTRACT

A method and telecommunications node for synchronising the content of a first node database such as for example of a Manager Management Information Base (MIB) with another node's database, such as for example an Agent MIB. The first node sends a synchronization request to the second node indicating the time when the first node was last updated. The second node scans through a list of changes dating from its own last update until the first node's last update, said scan being performed in a last-in-first-out (LIFO) fashion. If an item was found to be deleted, there is no point in scanning further ahead for creation or changes on this item. If an item was created at a given time, there is no point in scanning further ahead for this item. If an item was changed (i.e. one of its attribute was modified), the scanning continues in order to sum all changes on this item. The second node then sends the sum of creations/changes/deletions for any relevant item to the first node, which in turns stores the information along with the time when the second node was last updated.

### BACKGROUND OF THE INVENTION

1. Field of the Invention

The present invention relates to a method and system for information synchronization between two communication nodes.

2. Description of the Related Art

A large telecommunication management network includes various types of Network Resources (NRs). NRs may include communications nodes that insure the service provision to network subscribers, such as for example in the case of a cellular telecommunications network. Such a network may include nodes like Mobile Switching Centers (MSCs), Base Station Controllers (BSCs), Base Stations (BSs), Packet Data Service Nodes (PDSNs), Home Location Registers (HLRs), Home Agents (HAs) and the like, which are viewed as NRs from the perspective of the telecommunication management network. The later exercises supervision, monitoring, and control on its NRs. Within the management network, the NRs are represented by a set of software objects called Management Objects (MOs), which are maintained using various network management applications.

The use of software objects (MO instances) to represent the NRs for large networks management is a key characteristics of modern network management paradigms such as those advanced by the Telecommunication management network (TMN) of the International Telecommunication Union-Telecommunication Standardization Sector (ITU-T) and by the 3^{rd} Generation Partnership Project (3GPP) Integration Reference Point framework for 3G wireless networks.

In a large telecommunication management network, there is a distinction between one type of applications called Manager and another type of applications called Agent. In general, the Agent manages the NRs on behalf of Managers, i.e. the Managers do not directly interact with the NRs. Rather, the Managers control the NRs by sending instructions to Agents, that in turns control the NRs. In such a context, the Agent typically has a Management Information Base (MIB), called Agent-MIB, which is a collection of MOs (including their attributes) representing all NRs under management of that Agent. Each Manager also has a MIB, called Manager-MIB that holds this particular Manager's perspective or knowledge about the NRs under its management in the form of MOs as well.

In an ideal situation, the various Manager-MIBs and the Agent-MIBs should be identical at all times. As the NRs can be added or deleted from the network, or their attributes updated, event notifications representative of these changes are issued by the NRs and sent to the appropriate Agent, which stores them in its MIB. Ideally, all these event notifications should also be relayed to the appropriate Manager so that its MIB is continuously synchronised with the one of the Agent.

However, because of various problems, such as communication problems between NRs and the Agent and/or due to communication problems between Agents and Managers and/or due to specific behaviours of Managers, the Manager-MIB and the Agent-MIB may not hold identical information regarding a given set of managed MOs. For example, some event notifications (also called herein events or notifications) may be received by the Agent but not received properly by the Manager.

In a large telecommunication network, oftentimes the number of MOs exceeds hundreds of thousands in number. Although the overall network topology is dynamic in nature, i.e., the individual MO states change, it is not uncommon that many types of MO state information are static or changed very infrequently. Examples of static MO information are the operational state of a given NR (e.g., most of time, the state of a given NR is “in service” and not changed to “out-of-service”), the inventory information such as the hardware serial number or software application version, the relations such as the peer communication partner of the node, etc.

Existing network management solutions do not take advantage of this common network behaviour. When the Manager decides to synchronize its Manager-MIB with the Agent-MIB, the existing solutions require the transfer of all Agent-MIB information, including the static information, i.e. the one that has not been changed since the last synchronization process between the Manager and the Agent. This results in the transfer of large amounts of information that is not required by the Manager. Such mode of transfer wastes both communication bandwidth and Manager and Agent's processing resources.

Another state-of-the-art solution involves an Agent that maintains a MIB that contains all MO with their current state, wherein each attribute of each MO is associated with a “modified time information”. Such solution requires large storage space for housing the MIB and long search time, since all attributes of all MOs must be individually searched to determine if the attributes have been changed after a certain time. Furthermore, this state-of-art solution does not take into consideration the case when a NR is removed from the network and the corresponding MO deleted from the Agent-MIB, i.e. the Agent-MIB no longer has information related to the deleted MO. On the other hand, adding deleted-MO information in the MIB requires large storage space and a longer search time since reconfiguration of a network, especially for newly deployed networks or when a network is migrating to newer technology, requires large amount of deletion and creation of MOs. If deleted-MO information is not added to the Agent-MIB, then the Manager has to compare the retrieved Agent-MIB information with its own Manager-MIB to decide if any MO has been removed. But such comparison again requires significant Manager's processing resources.

Yet another state-of-art solution uses event logs to capture network events that indicate MOs creations, MOs deletions and MOs attribute changes. In such scenarios, NRs emit network events that are captured by the event log. The Manager can retrieve all logs containing event notifications whose event time is later (grater) than a given time T1, where T1 is the last time the Manager-MIB was synchronized with the Agent-MIB. This solution requires the transfer of a set of logs which event times are later (greater) than T1. However, this set of logs can also contain redundant and obsolete information. For example, a series of MO attribute changes performed on the same attribute of a given MO may have redundant information since only the last item of the series is of significance for the purpose of synchronization. The transfer of redundant information again requires large bandwidth of transmission between the Agent and the Manager and wastes Manager processing resources.

Although there is no prior art solution as the one proposed hereinafter for solving the above-mentioned deficiencies, the U.S. Pat. No. 5,943,676 bears some relation with the field of the present invention. In the U.S. Pat. No. 5,943,676, a data synchronisation method involves storing a recurrent event, such that a database, in which the recurrent event is stored as a single recurring record, can be synchronised with a database in which the same recurring event is stored as a series of records. The individual records are processed to form a synthetic recurring record representing the set of records, and synchronisation decisions are taken based on a comparison of the synthetic record with the recurring record of the other database. The U.S. Pat. No. 5,943,676 is limited to a method for synchronising a plurality of records with another single record from a different database.

The co-owned U.S. patent application Ser. No. 10/849142 also bears some relation with the field of the present invention. This patent application teaches a method and system that takes advantage of the common network behavior associated with the fact that although the overall network topology is dynamic in nature, i.e., the individual MO states change, it is not uncommon that many kinds of MO state information are static or changed very infrequently. In this U.S. patent application, a method and associated agent are disclosed in a management system of a network, wherein the management system comprises at least one manager and the agent comprises at least one old Management Information Table (MIT) containing Management Information (Ml) from a plurality of network resources. The agent comprises a Management Information Module capable of gathering Management Information (Ml) from the network resources into a current MIT. The agent also comprises a Database Handling Module capable of, following an event, associating one manager to the event, verifying if the associated manager is associated with one old MIT, building a Management Information Notification (MIN) from at least the current MIT, associating the associated manager with the current MIT, freezing the current MIT into a further old MIT and creating a further current MIT. The agent further comprises a Communication Module capable of sending the built MIN to the associated manager. The disclosure of this patent application is limited to a method and system for using multiple time stamped databases within the agent for synchronization with the manager.

The U.S. Pat. No. 5,924,096 also bears some relation with the field of the present invention. In this patent, methods and systems are provided for synchronising local copies of a distributed database. Each data item is associated with a timestamp or other type of tag. The index tag associated with the data items in the database can be used to quickly determine the events which occurred after an event corresponding to a given tag value. The time of an event is used to determine whether it applies to the next database updated. The disclosure of the U.S. Pat. No. 5,924,096 is silent about the direction of the database parsing.

Accordingly, it should be readily appreciated that in order to overcome the deficiencies and shortcomings of the existing solutions, it would be advantageous to have a fast and efficient method and a corresponding system for effectively synchronizing two databases of two telecommunications nodes, such as for example a Manager MIB with an Agent MIB. The present invention provides such a method and system.

### SUMMARY OF THE INVENTION

In one aspect, the present invention is a method for synchronisation between a first and a second telecommunications nodes, the method comprising the steps of:

a. responsive to a trigger of a synchronisation between the first and second telecommunications nodes, parsing at the second node an information database from the most recent data item to the oldest data item, and for each parsed item:
a.1. if the item is created and no other occurrence of the data item was encountered before, insuring that the item is included in a result for return to the first node;
a.2. if the item is deleted and no other occurrence of the data item was encountered before, insuring that the item deletion is included in the result list for return to the first node; and

a.3. if the item is updated and no other occurrence of the data item was encountered before, insuring that the item attributes are included in the result list for return to the first node.

In another aspect, the present invention is a telecommunications node comprising:

an information database comprising data items;

a processing unit that is configured to act, responsive to a trigger of a synchronisation between the telecommunications node and another telecommunications node to parse the information database from the most recent data item to the oldest data item, and for each parsed item:
if the item is created and no other occurrence of the data item was encountered before, to include the data item in a result for return to the first node;
if the item is deleted and no other occurrence of the data item was encountered before, to delete the data item from the result list for return to the first node; and
if the item is updated and no other occurrence of the data item was encountered before, to include data item attributes in the result list for return to the first node.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is an exemplary nodal operation and signal flow diagram of the preferred embodiment of the present invention;

FIG. 2.A is an exemplary flowchart diagram of a method associated with the preferred embodiment of the present invention;

FIG. 2.B is another exemplary flowchart diagram of a method associated with the preferred embodiment of the present invention;

FIG. 2.C is yet another exemplary flowchart diagram of a method associated with the preferred embodiment of the present invention;

FIG. 3 is yet another exemplary flowchart diagram of a method associated with the preferred embodiment of the present invention;

FIG. 4 is a exemplary simplified block diagram of a telecommunication node such as a management Agent implementing the preferred embodiment of the present invention; and

FIG. 5 is an exemplary high-level structure diagram of a data item.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a method and system to synchronize the content of a first node database such as for example of a Manager MIB with another node's database, such as for example an Agent MIB. Accordingly, for example, the first node, e.g. the Manager sends a synchronization request to the second node, e.g. to the Agent, indicating the time when the first node, e.g. the Manager, was last updated. The 2^{nd} node, e.g. the Agent scans through a list of changes dating from its own last update until the first node's last update, said scan being performed in a last-in-first-out (LIFO) fashion. If an item was found to be deleted, there is no point in scanning further ahead for creation or changes on this item. If an item was created at a given time, there is no point in scanning further ahead for this item. If an item was changed (i.e. one of its attribute was modified), the scanning continues in order to sum all changes on this item. The 2^{nd} node then sends the sum of creations/changes/deletions to the 1^{st} node, which in turns stores the information along with the time when the 2^{nd} node was last updated. The invention reduces the amount of update information required to be sent from a database to another (e.g. from the Agent to the Manager).

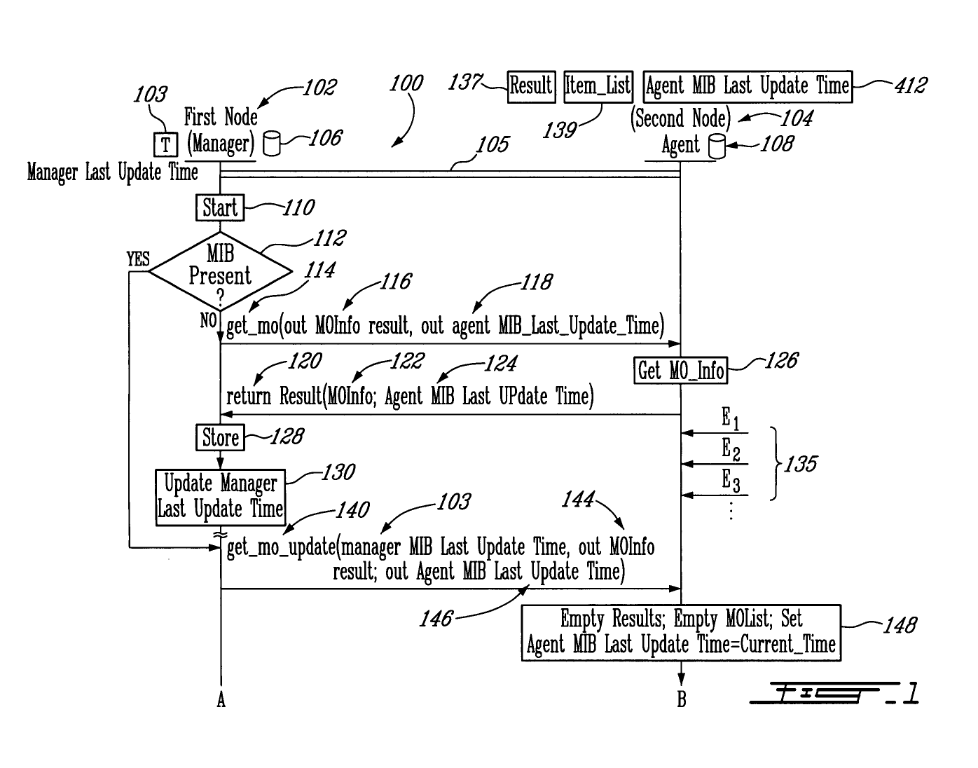

Reference is now made to FIG. 1, which is an exemplary nodal operation and signal flow diagram of the preferred embodiment of the present invention. Shown in FIG. 1 is telecommunication network 100 including a first telecommunications node (e.g. a Manager of a telecommunications management network) 102 and a second telecommunications node (e.g. an Agent of a telecommunications management network) 104. The first and second nodes 102 and 104 each comprise an information database 106 and 108 respectively, which comprise data items (e.g. MOs) that should be synchronized. For example, the information databases 106 and 108 may be MIBs containing items such as the previously described MOs. The nodes 102 and 104 are linked via an appropriate communication interface 105, such as for example a Management Information Request (MIR) interface. In action 110, the process of the present invention is started, and in action 112 the first node 102 determines if its information database 106 (e.g. a MIB) exists or is adequately populated. If not, i.e. if it is the first time that the first node 102 initiates a synchronization process, then the first node 102 issues a synchronization request 114 for the second node 104, such as for example a MO synchronization request that may have the form of a get_MO request. The synchronization request may comprise an indication of the expected results from the second node 104 in the form of “out MOInfoResult”, which indicates that the first nodes would expect MO Information as a result out from the second node 104, and “out AgentMIBLastUpdateTime” indicative of the expected synchronization time from the second node, i.e. for example from an Agent. The second node 104 receives the synchronization request 114, and in action 126 retrieves the expected result, i.e. for example the MO information requested by the first node 102, and returns it to the first node 102 using a synchronization return message 120 containing the MO information result 122 and the requested synchronization time 124 of the second node, e.g. of the Agent. The synchronization time of the second node 104 is set to the current time since the synchronization has just happened, and stored in a timer AgentMIBLastUpdateTime 412 of the second node 104. Upon receipt of the MO information, the first node 102 stores the information in its information database 106, action 128, and updates its last update time 103 with the received AgentMIBLastUpdateTime 124, action 130. This helps the first node 102 to keep track of the time when it was last synchronized with the second node 104.

If in action 112 it is rather determined that the first node 102 already comprises a populated information database 106, or alternatively, if at a later point in time the first node 102 decided to again synchronize its information database 106 with the information database 108 of the second node 102 in order to get information about newly received items 135 (e.g. event notifications) at the second node 104, the first node 102 initiates another synchronization process, also called herein a synchronization update, in action 140.

For this purpose, the first node 102 sends out a synchronization update request 140 that may have the form of a “getMOUpdate” request message comprising a parameter “managerMIBLastUpdateTime” 103 indicating the last time the information database 106 of the first node 102 (e.g. the manager) was synchronized with the information database 108 of the second node 104, the indication of the results expected out of the second node in the form of “out MOInfoResult” 144, which indicates that the first node would expect as a result MO Information, and “out AgentMIBLastUpdateTime” 146 indicative of the expected synchronization time of the second node, i.e. of the Agent 104. Responsive to the receipt of the synchronization update request 140, the second node 104 starts the process of building a synchronization update result to be returned to the first node 102. In action 148, it starts preparing its internal variables to be used for this purpose, i.e. it possibly creates, or empties if already existing and required a result storage 137 (e.g. a memory or other data repository) that is to store the synchronization update result to be returned to the first node 102, it further possibly creates, or empties if already existing and required an item list 139 that is to store each item from the database 108 that is processed, and it further sets the second node last synchronization time to the current time, since a synchronization process is under way. For example, the second node 104 may set again the timer 412 to the current time. In action 150, the second node 104 parses the information database 108, and retrieves one by one data items (e.g. MO records) from the information database 108 (e.g. MIB) in a last-in-first-out order, i.e. from the latest (newest) item to the older item. If the retrieval is a success as detected in action 152, i.e. for example the retrieved item is not the last item of the database, the second node then verifies if the item time is subsequent to the received “ManagerMIBLastUpdateTime” 103.

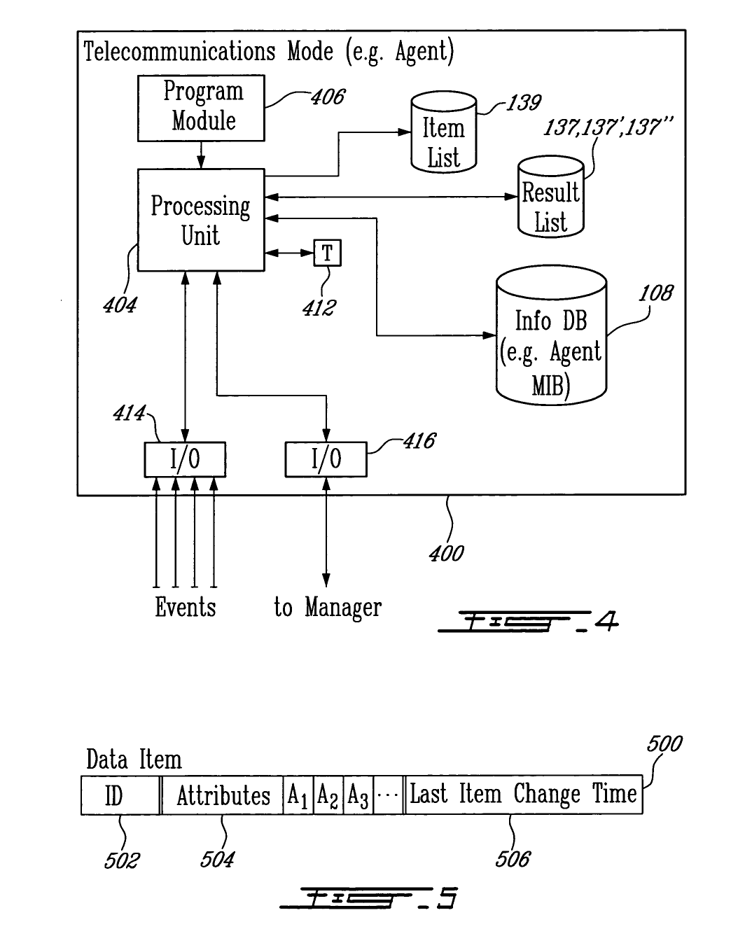

Reference is now made additionally to FIG. 5, which is an exemplary high-level structure diagram of a data item 500, which comprises a data item identifier 502, a series of data item attributes 504, and its last update time 506 indicative of the last time the data item content was altered. The last update time may contain the creation time of the data item, the last update time, or even the deletion time of the item in case the data item was deleted and this action was included in one of its attributes. For example, if the data item is an MO, the creation, deletion or update time of the MO is stored in an attribute field 504 of the MO.

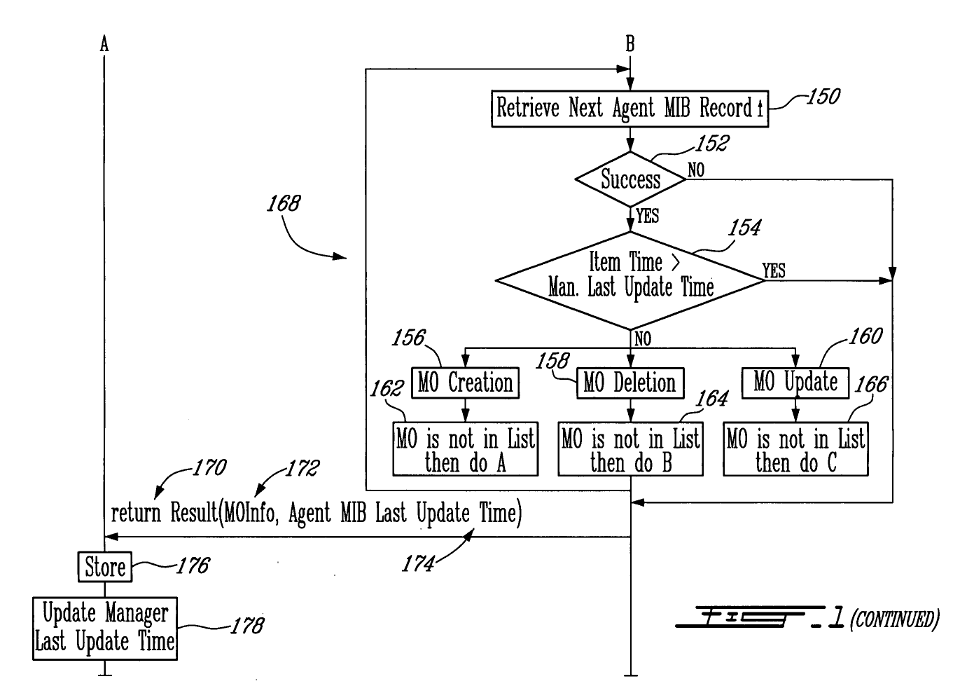

Referring back to FIG. 1, if the item time is subsequent to the received “ManagerMIBLastUpdateTime” 103 as detected in action 154, i.e. if the item is to be considered for the synchronization update, the second node 104 acts as follows:
if the data item is indicative of an item creation, i.e. that the data item shows it was newly created in the information database 108, as detected in action 156, then the second node 104 further detects if the item is not yet put in the Item List 139, and if it is not, then the second node 104 performs the series of action “A” shown in FIG. 2.A, which is a flowchart diagram of a method associated with the preferred embodiment of the present invention. The purpose of detecting if the item is not yet put in the Item List 139 is that, if the item is there, this means the item was already considered in a previous parse of the database related to an item creation or update, and in such case the item creation is meaningless and it should not be considered since other more recent information is already processed regarding this item. If the tests of action 162 are satisfied, with reference being now made jointly to FIG. 1 and to FIG. 2.A, in action 202 the item (e.g. the MO) is added to the Item List 139 to show it has been processed. In action 205 it is detected if a first occurrence of the item is already present in the Result List 137. This may be the case if this item occurrence was previously detected during the database parsing as an item deletion or updated, which are yet to be described. If the item is not yet present in the Result List 137, then the item and its attributes is added to this list, action 206. Otherwise, if the item is already present in the Result List 137, then the second node 104 acts to determine for each item attribute if it is not present in the item of the Result List, and if not, to add the item attribute to the item of the result List 137. In action 210 the process returns, and the next item is again obtained in action 150.
if the data item is indicative of an item deletion as detected in action 158 and if the data item is not in the Item List 139 as detected in action 164, the second node then performs the series of actions “B” shown in FIG. 2.B, which is another flowchart diagram of a method associated with the preferred embodiment of the present invention. With reference being now made jointly to FIG. 1 and to FIG. 2.B, in action 220 the item (e.g. the MO) is added to the Item List 139 to show that it has been processed. In action 222 it is detected if an occurrence of the item is already present in the Result List 137. This may be the case if this item was previously detected as an item creation, as described hereinbefore, or an item update that is yet to be described. If in action 222 it is detected that the item is already present in the result List 137, then the item is deleted from that list, action 224, since the most recent information of the database 108 (the parsing is made in a last-in-first-out manner) shows that the item was deleted. Then, the second node 104 acts to add the item deletion information to the Result List 137, action 226. In action 228 the process returns, and the next item is again obtained in action 150.
if the data item is indicative of an item attribute update (e.g. a MO attribute update) as detected in action 160 and that the data item under consideration is not present in the Item List 139, then the second node 104 performs the series of actions “C” shown in FIG. 2.C, which is yet another flowchart diagram of a method associated with the preferred embodiment of the present invention. With reference being now made jointly to FIG. 1 and to FIG. 2.C, in action 230 it is detected if the item under consideration is already present in the Result List 137. This may be the case if this item was previously detected as an item creation, as described hereinbefore, and added to the Result List 137. If the item is not detected in the Result List 137, then the item and its attributes is added to the Results List 137, action 232. Otherwise, if the item is detected as present in the Results List 137, then the second node acts to determine for each item attribute if it is not present in the item of the Result List, and if not, acts to add the item attribute to the item of the Result List 137. In action 236 the process returns, and the next item of the database 108 is again obtained in action 150.

When the process reaches the last item to be processed from the local database 108 and the action 152 shows an unsuccessful result in retrieving the next item, or when the next data item time is anterior to the last synchronization time 103 of the first node 102 and the action 154 outputs a positive response, the process exists the loop 169, and the Result List 137 that has been populated with synchronization information is returned to the first node 102 using a synchronization return result message 170 comprising the Result List 137 in the form of, for example, MO Info 172, and the last synchronization time of the second node 1040in the form of, for example, “AgentLastUpdateTime” 174. In action 176, the first node 102 acts to store in its information database 106 the synchronization update results, and in action 178 acts to update its last synchronization time 103 with the time received from the second node 104 in order to kept track of its last synchronization time.

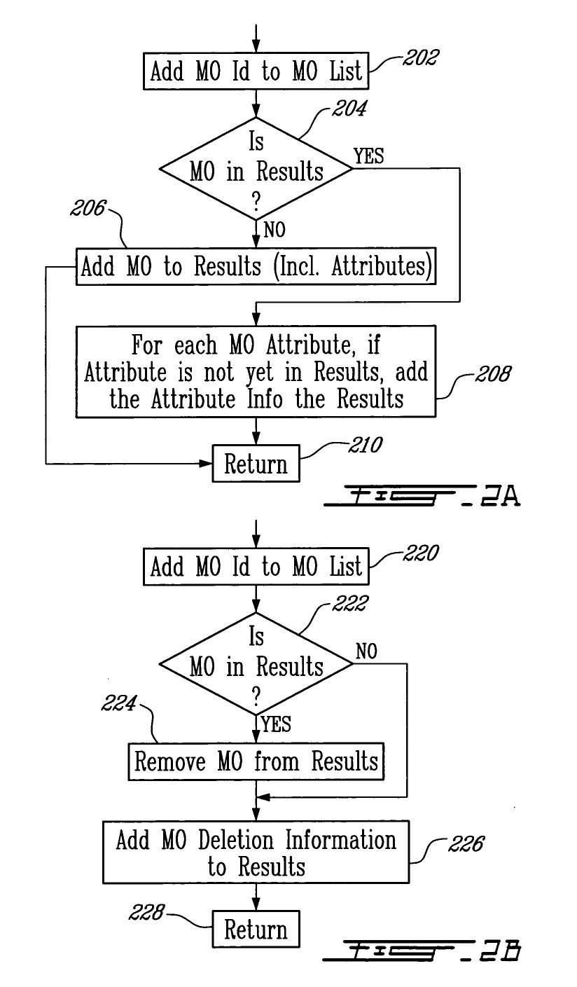

Reference is now made to FIG. 3, which is yet another flowchart diagram of a method associated with a variant of the preferred embodiment of the present invention. The method shown in FIG. 3 shows that the synchronization update process described hereinbefore may be alternatively started using other triggers then the receipt of a synchronization update request from the first node 102. For example, it may be performed periodically or as a result of other presetting or receipt of a given type of information, so that a preliminary Result List is built by the second node 104 in anticipation of a receipt of a synchronization update request from the first node 102. Thus, when such a request is received at a later point in time, the second node 104 already has at least a partially built Result List 137′ and can answer to the first node 102 faster. With reference to FIG. 3, in action 302, the Result List calculation is triggered, such as for example by the expiry of a timer or upon receipt of a given type of information (e.g. an event notification of a given type). In action 304, a preliminary Result List 137′ is being built in a manner similar with the one described hereinbefore in actions 148-166. In action 306, the preliminary Result List 137′ is stored by the second node 104. Later, the second node 104 receives a synchronization update request alike the synchronization update request 140 described in relation to FIG. 1, action 308. Responsive to the request, in action 310, the second node 104 again builds a final Result List 137″ by performing the same actions 148-166, which are applied in the present case on data items forming a sum of the preliminary Result List 137′ built previously plus all the data items (Delta) received by the second node 104 since the build time of the preliminary Result List 137”. Then, in action 312, the second node 104 returns the Result List 317″ to the first node 102 as described hereinbefore. By performing part of the calculation required to build the final Result List 137″ prior to the receipt of the synchronization update request from the first node 102, the second node 104 is capable of responding faster to the request form the first node 102.

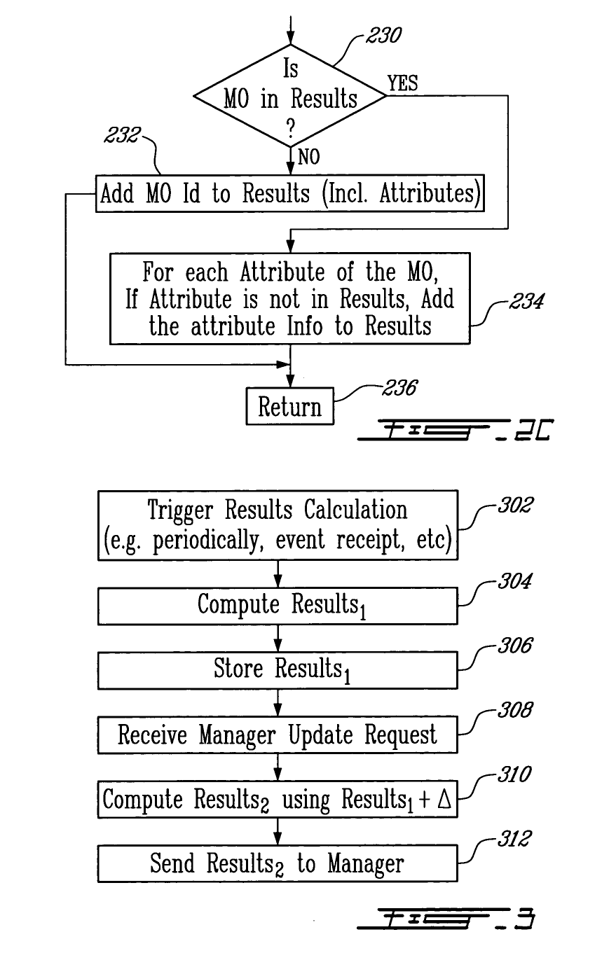

Reference is now made to FIG. 4, which is a simplified block diagram of a telecommunications node, such as a management network Agent implementing the preferred embodiment of the present invention. Shown in FIG. 4 is the telecommunications node 400 that comprises the information database 108 connected via appropriate communications means to a processing unit 404. The processing unit 404 is connected to a program module 406 that stores the application program(s) responsible for the intelligence of the node 400, i.e. that stores the instructions for performing the process described in relation to FIGS. 1, 2A-C, and 3. The processing unit 404 is also connected to the item list 139, the Result Lists 137, 137′ and 137″, and to the time information 412. Finally, the processing unit 404 is also connected to an I/O interface 414 responsible for receiving data items (e.g. the event notifications) and to another I/O interface 416 responsible for communicating with the first node 102 (e.g. the Manager). With reference being now made jointly to FIGS. 1 and 4, the application program of the program module 406 is first loaded into the processing unit 404 of the node 400. As data items are received at the interface 414, they are relayed via the unit 404 to the information database 108 where they are stored. Upon receiving a synchronization request or a synchronization update request from the first node 102 at the interface 416, or alternatively in a periodic manner or otherwise specified using internal setting, the second node 104 acts to start a Result List build process as described hereinbefore. The processing unit 404 acts to perform actions 148-172 as described hereinbefore in relation to FIGS. 1, 2.A-C and 3, using the information database 108, the item list 139 and the Result Lists 137, 137′ and 137”. As a result, the second node 104 returns to the first node 102 the synchronization results in message 170 as shown in FIG. 1.

Therefore, with the present invention it becomes possible to efficiently synchronise a first and second node, such as for example a management network's Manager and Agent.

Based upon the foregoing, it should now be apparent to those of ordinary skills in the art that the present invention provides an advantageous solution, which offers a simple and efficient method, system and node for synchronizing data items of two information databases. Although the system and method of the present invention have been described in particular reference to certain terminology (e.g. first and second nodes, Agent and Manager, information databases), it should be realized upon reference hereto that the innovative teachings contained herein are not necessarily limited thereto and may be implemented advantageously in various domains, including but being not limited to synchronization of information databases, synchronization of MIBs between two nodes such as an Agent and a Manager, or any other type of synchronization between any types of information repository, including memories, databases, lists and the like, all of which are herein designated under the appellation of information databases. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for synchronisation between a first and a second telecommunications nodes, the method comprising the steps of:
a. responsive to a trigger of a synchronisation between the first and second telecommunications nodes, parsing at the second node an information database from the most recent data item to the oldest data item, and for each parsed item:
a.1. if the item is created and no other occurrence of the data item was encountered before, insuring that the item is included in a result for return to the first node;
a.2. if the item is deleted and no other occurrence of the data item was encountered before, insuring that the item deletion is included in the result list for return to the first node; and
a.3. if the item is updated and no other occurrence of the data item was encountered before, insuring that the item attributes are included in the result list for return to the first node.

2. The method claimed in claim 1, wherein the parsing at the second node of the information database from the most recent data item to the oldest data item is only performed for data items that include update time information that is posterior to a given time stamp.

3. The method claimed in claim 1, further comprising the steps of:
b. receiving at the second node a synchronisation request from the first node, the synchronisation request comprising the given time stamp, which is indicative of a last time the first node was synchronised with the second node; and
c. returning to the first node the result list.

4. The method claimed in claim 1, wherein the first node is a management network Manager, the second node is a management network Agent, the information database is a Management Information Base (MIB) and the data items are Management Objects (MOs).

5. The method claimed in claim 4, wherein the MOs contain an MO identifier, MO attributes and an MO update time.

6. A telecommunications node comprising:
an information database comprising data items;
a processing unit that is configured to act, responsive to a trigger of a synchronisation between the telecommunications node and another telecommunications node to parse the information database from the most recent data item to the oldest data item, and for each parsed item:
if the item is created and no other occurrence of the data item was encountered before, to include the data item in a result for return to the first node;
if the item is deleted and no other occurrence of the data item was encountered before, to delete the data item from the result list for return to the first node; and
if the item is updated and no other occurrence of the data item was encountered before, to include data item attributes in the result list for return to the first node.

7. The telecommunications node claimed in claim 6, wherein the parsing by the processing unit of the information database from the most recent data item to the oldest data item is only performed for data items that include update time information that is posterior to a given time stamp.

8. The telecommunications node claimed in claim 6, wherein the node received a synchronisation request from the other node, the synchronisation request comprising the given time stamp, which is indicative of a last time the other node was synchronised with the telecommunications node, wherein the telecommunications node returns to the other node the result list.

9. The telecommunications node claimed in claim 6, wherein the telecommunications node is a management network Manager, the other node is a management network Agent, the information database is a Management Information Base (MIB) and the data items are Management Objects (MOs).

10. The telecommunications node claimed in claim 9, wherein the MOs contain an MO identifier, MO attributes and an MO update time.
